(19) United States
(12) Patent Application Publication
(10) Pub. No.: US 2011/0311063 A1
(43) Pub. Date: Dec. 22, 2011

(54) EMBEDDING AND EXTRACTING ANCILLARY DATA

(76) Inventors: Fransiscus Marinus Jozephus De Bont, Eindhoven (NL); Amoldus Werner Johannes Oomen, Eindhoven (NL); Erik Gosuinus Petrus Schuijers, Eindhoven (NL)

(21) Appl. No.: 13/256,229

(22) PCT Filed: Mar. 5, 2010
(86) PCT No.: PCT/IB10/50955

§ 371 Date: Sep. 13, 2011

(30) Foreign Application Priority Data
Mar. 13, 2009 (EP) 09155086.3

(51) Int. Cl. G10L 19/00; H04R 5/00

(52) U.S. Cl. 381/22; 704/500; 381/23; 704/E19.001

(57) ABSTRACT

The invention proposes a method for embedding an ancillary data into a compressed audio signal. This is achieved by replacing Least Significant Bits (LSBs) in at least one frequency subband of the compressed audio signal by the ancillary data. When replacing LSB bits of compressed subband signals with the ancillary data, the subband signal is effectively modified, resulting in a different decoded output. The replaced LSB bits corresponding to the ancillary data are conveyed as part of the bitstream and can be easily extracted at the decoder. In such a way the decoder obtains the ancillary data that can be used for more advanced audio reproduction at the decoder. The compressed audio itself maintains a good audio quality despite the replacement of the LSB bits of the frequency subband, because the LSB bits do not contribute to the audible artefacts.

### FIELD OF THE INVENTION

The invention relates to embedding ancillary data. The invention also relates to extracting ancillary data.

### BACKGROUND OF THE INVENTION

MPEG Surround as specified in ISO/IEC 23003-1:2007, MPEG Surround, is a multi-channel audio coding scheme utilizing a parametric representation of the spatial image. Due to its high coding efficiency, MPEG Surround can be used to, in a backward compatible fashion, extend a mono/stereo coder towards multi-channel, requiring only a low additional bit rate. The MPEG Surround data can be stored or transmitted as a separate stream or embedded in the ancillary data portion of the down-mix data. In order to transport MPEG Surround data as part of a core coder bit-stream, the core coder needs to support ancillary data embedding. However, there are many down-mix coders such as e.g. Sub-Band Coding (SBC) that is mandatory for high quality audio streaming over Bluetooth A2DP, which do not have a capability to store ancillary data in the bit-stream. The MPEG Surround specification in Section 7.3 indicates how the technique called “buried data” can be used to transport MPEG Surround data in the bit-stream. However, this technique can be applied only to the downmix encoded as PCM. The technique is based on the assumption that the bits in the bitstream are shared between PCM data and the MPEG Surround data. A higher bit allocation to MPEG Surround data results in lower audio quality as fewer bits are available for encoding the audio signal. The “buried data” technique has as a disadvantage that it cannot be used for the compressed audio signal.

### SUMMARY OF THE INVENTION

It is an object of the present invention to provide embedding ancillary data into a compressed audio signal, and extracting ancillary data from a compressed audio signal. The invention is defined by the independent claims. The dependent claims define advantageous embodiments.

One aspect of the invention proposes a method for embedding an ancillary data into a compressed audio signal. This is achieved by replacing Least Significant Bits (LSBs) in at least one frequency subband of the compressed audio signal by the ancillary data.

When replacing LSB bits of compressed subband signals with the ancillary data, the subband signal is effectively modified, resulting in a different decoded output. The replaced LSB bits corresponding to the ancillary data are conveyed as part of the bitstream and can be easily extracted at the decoder. In such a way the decoder obtains the ancillary data that can be used for more advanced audio reproduction at the decoder. The compressed audio itself maintains a good audio quality despite the replacement of the LSB bits of the frequency subband, because the LSB bits least contribute to the potential audible artefacts.

In an embodiment, the LSB bits to be replaced by the ancillary data are determined based on a psychoacoustic criterion. The subjective impact caused by the difference in output as a result of LSB modification is minimized by applying a psychoacoustic criterion controlling both the location as well as the amount of LSB bits that can be modified. The compressed audio itself maintains then a good audio quality despite the replacement of the LSB bits of the frequency subband, because those selected LSB bits do not contribute to the audible artefacts. The allocation of the LSB bits is determined implicitly in the decoder by employing the same criterion as used in the encoder. The similarity of the LSB bits allocation at the decoder side can be assessed at the encoder beforehand. Therefore, no additional indication information for LSB bits allocation is required, or only limited additional indication information is required in case of differences between the allocation used at the encoder and the expected allocation at the decoder to indicate these differences.

In a further embodiment, an allocation of the LSB bits to be replaced by the ancillary data is indicated by indication information embedded in the LSB bits. At the decoder side indication information is required to identify the location and the amount of LSB bits that constitute the ancillary data. A fixed number of LSB bits that is allocated by default to specific subbands are used to convey this indication information. These bits are allocated for every frame.

In a further embodiment, the compressed audio signal is obtained using an SBC encoding. The SBC encoding has no inherent support for ancillary data. The SBC encoding might be modified to accept ancillary data to be conveyed in the LSB bits of one or more subband signals. In other words, the replacement of the LSB bits with the ancillary data becomes a part of the audio compression. In this way the SBC encoder can create a bit-stream that holds ancillary data. The LSB bits allocation can vary in time to efficiently use the frequency subbands such that the allocated LSB bits do not contribute to potential audible artefacts. Alternatively, the replacement of the LSB bits with the ancillary data could be performed as a post-processing step after the encoding. It should be clear that the resulting SBC bit-streams are compatible to existing SBC decoders.

In a further preferred embodiment, the ancillary data comprise data to be employed for processing of a decoded compressed audio signal. This allows an additional processing, such as a post-processing of the decoded compressed audio signal to change characteristics of the audio signal, e.g. parameter controlled virtualization processing.

In a further embodiment, the ancillary data comprise MPEG Surround data.

The MPEG Surround down-mix is encoded using the e.g. SBC encoder. The MPEG Surround data is also input to the SBC encoder and is conveyed in the LSB bits of one or more subband signals of the SBC encoded down-mix signal. After transmission and/or storage of the resulting bit stream, the SBC decoder decodes the stereo down-mix and extracts the MPEG surround data. An MPEG surround decoder combines the stereo down-mix and the MPEG Surround data into a multi-channel audio signal.

Another aspect of the invention provides a method for extracting ancillary data from the input compressed audio signal. It should be appreciated that the features, advantages, comments, etc. described above are equally applicable to this aspect of the invention.

The invention further provides an embedding device, and an extracting device, as well as a decoder comprising the extracting device according to the invention.

These and other aspects, features and advantages of the invention will be apparent from and elucidated with reference to the embodiment(s) described hereinafter.

### BRIEF DESCRIPTION OF THE DRAWINGS

FIG. 1 shows a flow chart of an embodiment of a method for embedding an ancillary data into a compressed audio signal according to the invention;

FIG. 2 shows an example of replacing LSB bits in at least one frequency subband of the compressed audio by the ancillary data;

FIG. 3 shows a flow chart of an embodiment of a method for embedding the ancillary data into a compressed audio signal modified to indicate an allocation of the LSB bits to be replaced by the ancillary data by indication information embedded in the LSB bits;

FIG. 4 shows schematically an example of an embedding device for embedding ancillary data into a compressed audio signal according to the invention;

FIG. 5 shows schematically an example of an extracting device for extracting ancillary data from an input compressed audio signal;

FIG. 6 shows an example of a decoder for decoding an input compressed audio signal comprising an extracting device according to the invention.

### DETAILED DESCRIPTION OF EMBODIMENTS OF THE PRESENT INVENTION

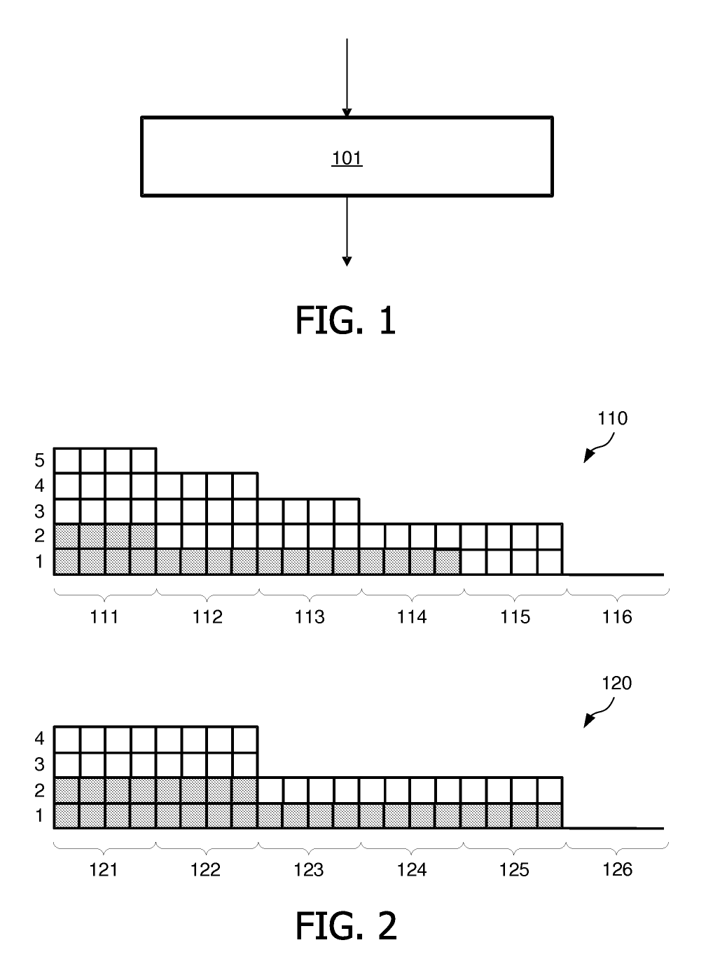

FIG. 1 shows a flow chart of an embodiment of a method for embedding ancillary data into a compressed audio signal according to the invention. The method comprises a step 101 of replacing LSB bits in at least one frequency subband of the compressed audio by the ancillary data. The compressed audio signal might be obtained by the SBC, AAC, MP3, or HE-AAC encoders. The compressed audio signal comprises at least one frequency subband. Here, the frequency subband refers, both, to a filterbank subband representation as provided by e.g. SBC, as well as a transform representation as provided by e.g. AAC. Often the subbands from a subband filter are referred to as subsignals, while subbands from a transform are referred to as frequency coefficients. It should be noted that the LSB bits in both cases refer to bits of quantized spectral coefficients. The ancillary data can be of any type. However, preferably it should comprise data related to spatial audio information that could be used to improve the spatial audio quality of the compressed audio. An example of such ancillary data is e.g. MPEG Surround data formatted into a data structure similar to this specified in Section 7.3.2 of ISO/IEC 23003-1:2007, MPEG Surround. Alternatively, the ancillary data might comprise e.g. Spectral Band Replication data, Parametric Stereo data, meta data such as timing information, or loudness levels, or Spatial Audio Object Coding data allowing for interactive mixing at the decoding side.

FIG. 2 shows an example of replacing LSB bits in at least one frequency subband of the compressed audio by the ancillary data. In FIG. 2 an example of the compressed audio signal is depicted. Such compressed audio signal could be obtained by the SBC coder with the following configuration parameters: sampling frequency of 48 kHz, stereo channel mode, 8 subbands, and block length of 4. The graph 110 corresponds to a left channel audio, while the graph 120 corresponds to a right channel audio. For each of the channels six subbands are depicted 111-116 and 121-126 for the left channel and the right channel, respectively. Only the six subbands are depicted (instead of the eight prescribed subbands) for clarity of representation reasons, since no bits have been allocated to the remaining subbands in the present example. The compressed audio signal for a first subband 111 of the left channel audio 110 requires the prescribed block length of 4 bits and a block width of 5 bits, resulting in 20 bits. It should be noted that the block length corresponds to the number of subband samples in the subband. The subband 112 requires the prescribed block length of 4 bits and a block width of 4 bits, resulting in 16 bits. While 12 bits, 8 bits, and 8 bits are required for subbands 113, 114, and 115, respectively. Similarly, for the right audio channel 120, 16 bits, 16 bits, 8 bits, 8 bits, and 8 bits, are required for the subbands 121, 122, 123, 124, 125, respectively. As prescribed by the invention the LSB bits of some of the subbands can be used for embedding the ancillary data. These bits are marked grey in FIG. 2. Hence, eight LSB bits in the subband 111, four LSB bits in the subband 112, four LSB bits in the subband 113, and four LSB bits in the subband 114, are used for embedding the ancillary data. Embedding of the ancillary data means here replacing the indicated LSB bits with the ancillary data. Although, the allocation of LSB bits to be replaced with the ancillary data varies in subbands, it is also possible to use a fixed LSB bits allocation. The advantage of varying LSB bits allocation is that the bits allocation can be adapted to the actual audio content in the compressed audio in order to not compromise the audio quality. By varying the LSB bits allocation over the frequency subbands a distortion created by the replaced LSB bits within the subbands can be controlled. The control of the LSB bits allocation allows shaping of the distortion in a spectral domain such that distortion remains masked.

In an embodiment, the LSB bits to be replaced by the ancillary data are determined based on a psychoacoustic criterion. This psychoacoustic criterion has as a goal choosing the subbands and the LSB bits for replacement with the ancillary data for which the smallest impact on the perception is expected. The psychoacoustic criterion could e.g. be realized by determining a masking curve of the original audio signal on the grid of the subband representation. Such masking curve indicates how much noise may be added in each frequency band. The bands in which most of noise could be added are e.g. selected for embedding of the ancillary data. Alternatively, this criterion can be further improved by comparing the distortion of the compressed audio signal, encoded using e.g. the SBC encoding, with the determined masking curve. Consequently, the LSB bits to be replaced by the ancillary data can be selected such that the overall distortion (comprising both quantization by the SBC encoding and embedding ancillary data in LSB bits of the subbands) is approximately equal over all subbands compared to the masking curve. Combining the SBC encoding with the ancillary data embedding is advantageous as it allows minimizing of the impact of ancillary data embedding on the perceptual audio quality. If the compressed audio signal is a pre-encoded signal e.g. an SBC bit-stream, the higher frequencies are already coarsely quantized leaving little space for embedding the ancillary data. However, if the embedding of the ancillary data is combined with compression of an audio signal using e.g. SBC encoding, there exists a space for embedding of the ancillary data, which is preferably controlled by the encoding and embedding parameters.

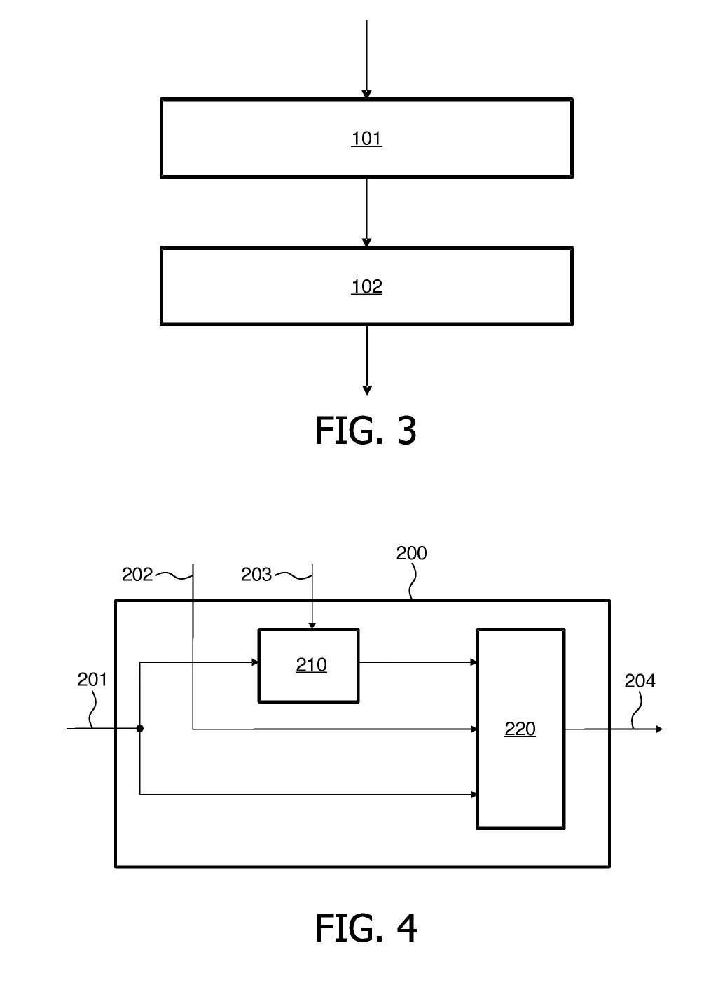

FIG. 3 shows a flow chart of an embodiment of a method for embedding the ancillary data into a compressed audio signal modified to indicate an allocation of the LSB bits to be replaced by the ancillary data by indication information embedded in the LSB bits. The method comprises the step 101 of replacing LSB bits in at least one frequency subband of the compressed audio by the ancillary data. A step 102 comprises embedding indication information to indicate the allocation of the LSB bits to be replaced by the ancillary data in the compressed audio signal. This indication information is similarly to the ancillary data embedded in the LSB bits of the compressed audio signal. Although the step 102 follows the step 101, the sequence of these two steps could be interchanged.

The indication information might be comprised at a predetermined fixed location, for example, in a predetermined number, e.g. 16 bits, of the LSB bits of the first subband in a frame. Alternatively a method described in Section 7.3.2 of ISO/IEC 23003-1:2007, MPEG Surround could be adopted to indicate the indication information in the bitstream comprising the compressed audio signal with the embedded ancillary data.

In a further embodiment, the compressed audio is obtained using the SBC encoding. The SBC encoding offers a possibility for a relative high bit-rate thereby allowing more space for embedding of the ancillary data. Furthermore, for the SBC encoding less care needs to be taken to make sure that no audible artefacts occur (e.g. a simplified psychoacoustic model might be used). The SBC also becomes more and more popular as a communication codec between various communication devices (e.g. phones, or car radios).

However, next to the SBC encoding, any other transform or subband encoding could be used. Especially encoding techniques belonging to this class that do not support the ancillary data can benefit from the embedding of the ancillary data according to the invention.

In a further embodiment, the ancillary data comprise data to be employed for processing of a decoded compressed audio signal. As indicated before, the ancillary data preferably should comprise data related to spatial audio information that could be used to improve the spatial audio quality of the compressed audio. An example of such ancillary data is e.g. MPEG Surround data formatted into a data structure similar to this specified in Section 7.3.2 of ISO/IEC 23003-1:2007, MPEG Surround. Section 6 of the same specification describes how the MPEG Surround data is employed to create a multi-channel or binaural audio signal from a mono or stereo downmix signal and the MPEG Surround data.

In case of embedding the ancillary data comprising MPEG Surround data in the compressed audio signal comprising SBC encoded audio PCM samples, a number of SBC frames are required for embedding MPEG Surround data comprised in one MPEG Surround frame. Assume that the SBC configuration is used as described for FIG. 2, except that the block length is now 16. This results in SBC frame length 8×16 (=128) subband samples, wherein 8 is the number of subbands, and 16 is the block length. The frame length of the MPEG Surround data is 1024 PCM samples, which correspond to 1024 subband samples of the SBC frames. Assume that the 1024 PCM frames encoded according to MPEG Surround standard result in 888 bits. Furthermore, assume that 72 bits are required for coding the indication information. Hence, 8 SBC frames are needed to accommodate 888 bits of the ancillary data and 72 bits of the indication information. In order to efficiently use the available bits, the 8 SBC frames are grouped into 4 groups of 2 SBC frames. For each group of 2 frames an indication information is used. Hence, for two channels and 4 groups for each of the channels, in total, 8 units of indication information are used. For subbands having fewer bits available for the subband samples than the amount indicated in the indication information, the minimum of these two values is used for the actual embedding of the ancillary data in the subband. Assume that the subband samples as depicted in FIG. 2 are used for the 8 SBC frames for each of the channels. Further, assume that the allocation 2, 1, 0, and 1 bits for the left channel is used, and the allocation 1, 0, 1, and 0 for the right channel is used. The allocation of 2 bits for the left channel means that for the first group of two SBC frames 2 bits per subband are allocated to the ancillary data. This results in 2 (for 2 SBC frames)×5 (for 5 subbands)×16 (for block length)×2 (for allocated bits in each of the subbands)=320 bits available for the ancillary data. Subsequently the allocation of 1 bit per channel results in 160 bits available for the ancillary data.

This in turn for the 2, 1, 0, 1 bits allocation for the left channel and 1, 0, 1, 0 bits allocation for the right channel results in total in 960 bits, which are sufficient to accommodate the actually required 888 bits of the ancillary data.

FIG. 4 shows schematically an example of an embedding device 200 for embedding ancillary data 202 into a compressed audio signal 201 according to the invention. The embedding device 200 comprises an allocation circuit 210 for determining the LSB bits allocation for replacement with the ancillary data based on a psychoacoustic criterion 203 provided to the circuit 210. An example of such criterion 203 is a minimization of the energy of the embedded data with respect to a masking threshold over all subbands. The embedding device 200 further comprises a replacement circuit 220 that replaces the LSB bits allocated by the allocation circuit 210 in the compressed audio signal 201 with the ancillary data 202, resulting in an output compressed audio signal 204.

It should be clear that when the LSB bits allocation is fixed the allocation circuit 210 is redundant and does not need to be comprised in the embedding device 200. However, in such a case this fixed LSB bit allocation should be communicated to the decoder side in order to enable a proper extraction of the ancillary data 202 from the compressed audio signal 204 at the decoder side.

A further aspect of the invention is a method for extracting ancillary data from an input compressed audio signal, characterized in that the ancillary data is extracted from LSB bits of at least one frequency subband of the input compressed audio. Basically, the extracting method is a reverse method to the embedding method. Based on the LSB bits allocation, either fixed or adaptive, to the ancillary data the ancillary data is detected and extracted from the input compressed audio in which the ancillary data has been embedded according to the present invention.

The preferred embodiments for the method for embedding ancillary data into a compressed audio signal are also applicable to the method for extracting ancillary data from the input compressed audio signal.

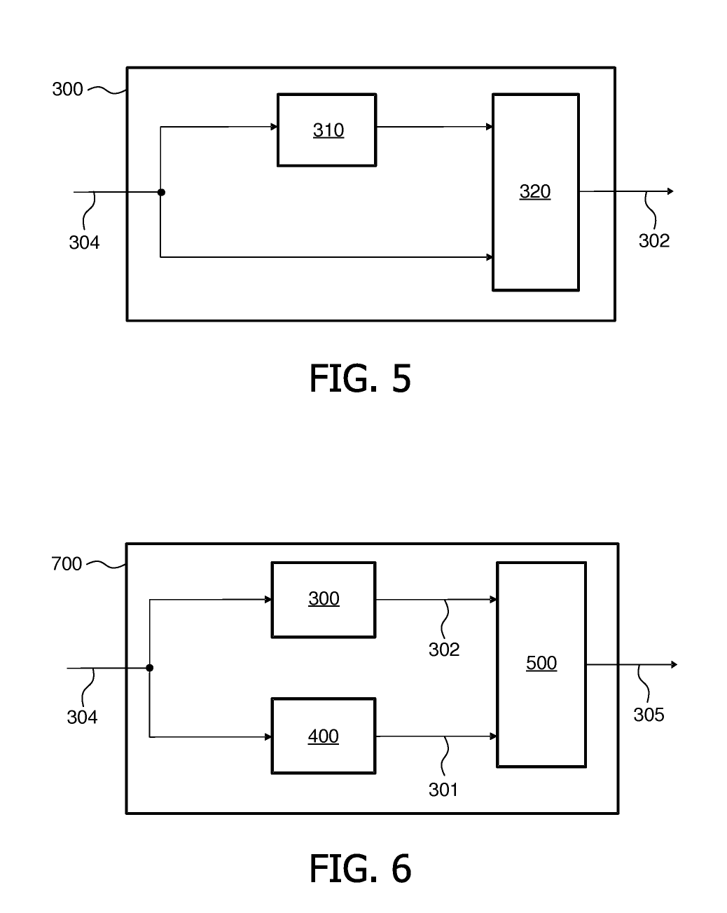

FIG. 5 shows schematically an example of an extracting device 300 for extracting ancillary data 302 from an input compressed audio signal 304. The input compressed audio signal 304 corresponds to the compressed audio signal 204 which is modified to have the ancillary data 202 embedded in the LSB bits in at least one frequency subband of the compressed audio signal 201. The extracting device 300 comprises an allocation-extracting circuit 310 for extracting the allocation of the LSB bits to the ancillary data 302. The allocation determined by the allocation-extracting circuit 310 is fed into an extraction circuit 320, which extracts based on this allocation the ancillary data 302 from the input compressed audio signal 304.

It should be clear that when the LSB bits allocation is fixed the allocation-extracting circuit 310 is redundant and does not need to be comprised in the extracting device 300. However, in such a case this fixed LSB bit allocation should be communicated to the extracting device side in order to enable a proper extraction of the ancillary data 302 from the input compressed audio signal 304.

FIG. 6 shows an example of a decoder 700 for decoding an input compressed audio signal 304 comprising an extracting device according to the invention. The decoder 700 comprises the extracting device 300 for extracting the ancillary data. Further, the decoder 700 comprises a first decoder 400 for decoding the input compressed audio signal, and a processing circuit 500 for combining an output signal 301 of the first decoder 400 and the ancillary data 302. In particular, the processing circuit 500 might comprise a second decoder that decodes the output signal 301 of the first decoder 400 and the ancillary data 302 into a multichannel audio signal, a binaural audio signal, or any other suitable audio signal. An example of the first decoder 400 is the SBC decoder. An example of the second decoder 500 is the MPEG Surround decoder. The second decoder receives the mono or stereo signal 301 and the MPEG Surround data 302. It then renders the mono or stereo signal 301 into a multi-channel signal 620 or binaural audio signal 610 as prescribed by the MPEG Surround data. The MPEG Surround data is preferably randomized before embedding as the ancillary data in the compressed audio signal. Randomization of the MPEG Surround data is prescribed in Section 7.3.4.2 of ISO/IEC 23003-1:2007, MPEG Surround.

The present invention can also be applied to the transcoding e.g. transcoding from HE-AAC/MPEG Surround, wherein the MPEG Surround data is embedded in the bitstream using a so-called ancillary data channel, into SBC/MPEG Surround, wherein the MPEG Surround data is embedded using the present invention.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term “comprising” does not exclude the presence of other elements or steps.

Furthermore, although individually listed, a plurality of circuit, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. In addition, singular references do not exclude a plurality. Thus references to “a”, “an”, “first”, “second” etc. do not preclude a plurality. Reference signs in the claims are provided merely as a clarifying example and shall not be construed as limiting the scope of the claims in any way. The invention can be implemented by circuit of hardware comprising several distinct elements, and by circuit of a suitably programmed computer or other programmable device.

1. A method for embedding an ancillary data (202) into a compressed audio signal (201), characterized by replacing LSB bits in at least one frequency subband (111, 112, 113, . . . ) of the compressed audio signal by the ancillary data.

2. A method according to claim 1, wherein the LSB bits to be replaced by the ancillary data (202) are determined based on a psychoacoustic criterion.

3. A method according to claim 1, wherein an allocation of the LSB bits replaced by the ancillary data (202) is indicated by indication information embedded in the LSB bits.

4. A method according to claim 1, wherein the compressed audio signal (201) is obtained using a Sub-Band Coding encoding.

5. A method according to claim 1, wherein the ancillary data (202) comprise data to be employed for processing of a decoded compressed audio signal.

6. A method according to claim 1, wherein the ancillary data comprise MPEG Surround data.

7. An embedding device (200) for embedding ancillary data (202) into a compressed audio signal (201), characterized in that the embedding device comprises a replacement circuit (220) for producing an output compressed audio signal in which LSB bits in at least one frequency subband of the compressed audio signal are replaced by the ancillary data.

8. A method for extracting ancillary data (302) from an input compressed audio signal (304), characterized in that the ancillary data are extracted from LSB bits of at least one frequency subband of the input compressed audio signal.

9. A method according to claim 8, wherein an allocation of the ancillary data (302) in the LSB bits is indicated by indication information embedded in the LSB bits.

10. A method according to claim 8, wherein the ancillary data (302) comprise data to be employed for processing of a decoded compressed audio signal.

11. A method according to claim 10, wherein the ancillary data (302) comprise MPEG Surround data.

12. An extracting device (300) for extracting ancillary data (302) from an input compressed audio signal (304), characterized in that the extracting device comprises an extracting circuit (320) for extracting the ancillary data from LSB bits of at least one frequency subband of the input compressed audio signal.

13. A decoder (700) for decoding an input compressed audio signal (304), the decoder (700) comprising:
an extracting device (300) according to claim 12 for extracting ancillary data;
a first decoder (400) for decoding the input compressed audio signal; and
a processing circuit (500) for combining an output signal of the first decoder and the ancillary data.

14. A decoder (700) according to claim 13, wherein the processing circuit (500) comprises a second decoder for decoding the output signal of the first decoder and the ancillary data into one of a multichannel audio signal and a binaural audio signal.
